(19) United States
(12) Patent Application Publication
(10) Pub. No.: US 2009/0320271 A1
(43) Pub. Date: Dec. 31, 2009

(54) Multifunctional device for carrying out automatic riveting process by numerical control and method thereof

(76) Inventors: Diego Perez Marin, Madrid (ES); Juan Ramon Astorga Ramirez, Madrid (ES)

Correspondence Address: WENDEROTH, LIND & PONACK, L.L.P., 1030 15th Street, N.W.,, Suite 400 East, Washington, DC, 20005-1503, US

(21) Appl. No.: 12/314,484

(22) Filed: Dec. 11, 2008

(30) Foreign Application Priority Data
Jun. 27, 2008 (ES) P200801941

(51) Int. Cl. B21D 39/00; B23P 11/00

(52) U.S. Cl. 29/524.1; 29/243.528

(57) ABSTRACT

The device comprises a robot (1) provided with a head (3) which comprises a plurality of single-function modules, each of them with the function of carrying out different and consecutive operations on the working zone of the pieces to rivet or fasten. The robot can be a precise articulated robot, a Cartesian machine, a parallel kinematics robot or other, while said modules can be located transversally, longitudinally or in a matrix in the head. The method provides operations for drilling, reaming and countersinking of different diameters, quality control of drill-holes, thickness checking of pieces, application of sealant, selection and supply of rivet, fastener or pin to rivet or fasten, fitting of the rivet, fastener or pin, riveting and/or fastening, fitting checking of the rivet, fastener or pin, cleaning, adjustment and checking of the aerodynamic tolerance.

### OBJECT OF THE INVENTION

As stated in the title of this descriptive specification, the following invention relates to a multifunctional device and method for automatic riveting by numerical control, the essential aim of which is to facilitate the union by means of riveting of pieces made of metal, carbon fiber, fiber glass or others, pieces with very strict manufacturing tolerances, such as those required in the aerospace industry, nevertheless without discarding other applications.

Other objectives of the invention consist of overcoming limitations of the state of the art in such a way that the invention can be possible in parallel kinematics machines and in Cartesian kinematics systems, eliminating the need for heavy multifunctional heads, in order to obtain simpler and less costly devices.

### PRIOR ART OF THE INVENTION

In the manufacture of structures, the manner of joining two pieces in order to obtain a single piece from a structural point of view can be achieved by various methods, such as welding, gluing, riveting, etc. In the case of the aerospace industry, historically, most structures have been joined by means of riveting. In metallic materials this is due to the need to use light materials such as aluminum alloys which are difficult to weld. In the case of composite materials, such as for example carbon fiber, glass “kevlar”, “glare”, etc., in the creation of the first substructures, for example the joining of spars to the lining of wings or stabilizers, this can be achieved by means of gluing methods such as co-curing, co-gluing, etc. Nevertheless, these methods are not possible in other type of structures, either due to the impossibility of having manufacturing methods suited to larger dimensions, as for example the joining in the lining to the spar, or because the materials to join have dissimilar characteristics, for example, the joining of a lining made of composite material or a metallic rib.

For this reason, the riveting of pieces in order to form substructures and structures currently remains as a typical method in the aerospace industry.

Moreover, in the aerospace industry large size structures determining pieces with thousands or tens of thousands of riveting positions are being increasingly used, therefore the automation of riveting operations greatly reduces the production costs.

In this regard, the inclusion of operations governed by numerical control systems allows highly efficient manufacturing processes to be obtained. Due to the large number of points on which to program the tasks to be performed by the system, the optimum programming method is the one known as “off-line”, in which the programming is carried out with a work station and in accordance with the three-dimensional graphic model of the piece assisted by computer without any need to have a real specimen piece.

Due to the strict manufacturing tolerances typical of the aerospace industry, riveting requires very sophisticated techniques, or the manufacture of very high precision tools for carrying out the drilling and riveting tasks manually or semi-automatically (with the consequent increase in finishing time for the pieces) or by means of automatic systems requiring high precision (with the consequent increase in the cost of the facilities).

Moreover, the amount of micro-operations to perform for a correct riveting, such as drilling to a very strict tolerance in diameter, in perpendicularity to the surface, in positioning, etc., the application of sealant, the checking of the thickness to join, along with the diversity of diameters, thickness and rivet types within a single piece, mean that automation requires multifunctional systems capable of performing all these micro-operations once positioned on a point. The most frequent solution to this problem entails the creation of systems with very complex multifunctional heads, with a multitude of own movements within the same head and therefore of considerable weight.

Typically, the automatic systems currently used consist of high precision massive systems (of the order of microns) and very high cost. Examples of these type of systems are machine tools with 5, 6 or more Cartesian kinematics axes (for example, machines of the “portal”, “gantry” or “column” type, etc.) on which a multifunctional head is arranged with its own movements and of great weight. In order to be able to move these heavy headstocks with sufficient precision and repetitiveness, very heavy and rigid machines are required. So, Patent ES 2155330 (application number 009800941) relating to a “Riveting process and facility for the construction of wings and stabilizers of aircraft” presents drawbacks related to the fact that it is only valid for machines of the “gantry” or “portal” type.

The characteristic automated systems of other industries, such as for example the anthropomorphic robots of the automobile industry, are not applicable because of their limited precision characteristics (of the order of millimeters) and repetitiveness, as well as their low payload, which makes them unable of precisely and repetitively positioning large or even medium weight multifunctional heads. Moreover, this type of robots do not accept sufficiently precise programming by the “off-line” methodology, so it is generally programmed by means of teaching the work positions on a specimen. In the case of an aerospace piece, the large number of positions to program makes this non-viable in both senses, technically and economically.

Only very recently have anthropomorphic robots started to be used but, in order to make up for their intrinsic lack of precision, measurement systems, temperature compensation systems and others have been added to them, though in all cases certain precisions are achieved (of the order of tenths of a millimeter) which are less than those achieved by traditional machines of the machine-tool type by numerical control. Due to their high complexity, difficulty in calibration and adjustment, and on account of the high cost associated with all the peripheral systems needed for achieving the required precisions, these systems are, for the time being, restricted to very specific applications, and the solution they provide cannot be extrapolated to most automatic drilling and riveting applications in the aeronautical or aerospace industry.

An intermediate situation regarding the systems described here is defined by parallel kinematics machines, which, owing to their precision of the order of hundredths (greater than that of articulated robots and even that of enhanced articulated robots), allow precise operations to be performed with heavier headstocks than those described for anthropomorphic robots, yet they are less costly than a Cartesian kinematics machine.

The fundamental problem of present-day automatic riveting systems by means of multifunctional heads governed by numerical control consists of the excessive weight necessary for their construction.

By means of spanish patent application number P 200401154, certain limitations in the movements needed to be carried out by the corresponding riveting machine are overcome, but there are drawbacks related to the fact that it eliminates the need for revolver (boomerang) type activations but not linear activations (by means of pneumatic or servo-actuated cylinders), nor does it eliminate the combination of those linear activations.

Moreover, when an attempt is made to perform an automatic riveting process, problems arise related to efficiently manage to combine in a single process the automatic riveting of pieces which include a large variety of diameters and lengths of a single type of rivet, as well as diversity in types of rivet, and mostly when the tolerances are very strict, as they are in the case of the aerospace industry. Historically, riveting has been carried out after performing the drilling and after carrying out a completely manual phase, in which the pieces that have been drilled are separated in order to perform the tasks of cleaning, elimination of burrs, application of different types of sealant (for example interposition sealant) and of shims/supplements (in order to eliminate plays between the pieces to rivet).

Present-day automatic riveting systems are usually characterized by being based on a carrier system (with high or very high precisions and repetitiveness or based on an anthropomorphic robot with enhanced precisions and repetitiveness by means of auxiliary systems) on which a multifunctional head is located with its own movements (rotary, revolver (boomerang) type, linear or combinations of these), in such a way that the positioning system locates the headstock in a position close to the work point and remains fixed while all the micro-operations of the riveting cycle are performed, being the headstock which, by means of activations, presents the different modules to the work point. Headstocks of this type, with multifunctional mechanisms and rotary mechanisms, are, for example, those described in patents US 2002173226 “Multispindle end effector”, US 2003232579 “Multi-spindle end effector”, WO 02094505 “Multi-spindle end effector”, and EP 0292056 “Driving mechanism and manipulator comprising a such a driving mechanism”. This type of headstocks need linear or rotary activation systems, or a combination of both, for high precision monitoring and control, with high quality materials and little or no wear within the useful life of the headstock, as well as implying a considerable increase in the weight and complexity of the system, therefore the maintainability and reliability are usually notably suffer. Owing to all this, the multifunctional head can represent a higher cost than that of the actual positioning system. Moreover, this complexity in the headstocks means that, as they are so heavy, sometimes close to half a ton, the performance of the positioning system in terms of precision and repetitiveness is very considerably reduced.

Moreover, there are patents for different CNC machines/headstocks from companies such as Brotje, Gemcor, Electroimpact, Alema, HydroControl and others which we consider do not display the characteristic features of the present invention.

### DESCRIPTION OF THE INVENTION

In order to achieve the objectives and avoid the drawbacks stated above, the invention consists of a multifunctional device and method for automatic riveting by numerical control, where the device is applicable to the union by means of riveting of pieces made of metal, carbon fiber, fiber glass or others with very strict manufacturing tolerances such as those required in the aerospace industry; the device comprising a machine or robot provided with a high precision positioning system, moved by numerical control and fitted with a headstock that is applied to the pieces to treat.

As a novelty, according to the invention, the head of device presents an array or plurality of single-function modules, each module effects consecutive operations on the same work point, in such a way that said single-function modules are presented to the said work point by the aforementioned positioning system. The positioning system comprising a numerical control Cartesian machine (gantry, portal, C, or other), a parallel kinematics machine or robot, a precise articulated robot, or a machine or robot with sufficient precision and repetitiveness for being applied to large structures with strict tolerances; while the different single-function modules are arranged on a frame which is attached rigidly and precisely to the union flange of the positioning system. The modules are located transversely, longitudinally, or in grid or matrix form on the frame, or are adapted to the accessibility limitations imposed by the piece to join or the securing tool for it.

According to a preferred embodiment of the invention, the different single-function modules are provided with their own mechanism which moves them closer to or further away from the piece to treat and which can, in some cases, be replaced by the actual advance provided by the numerical control positioning system. The mechanism being independent for each module, having a joint actuation for all the modules, or being independent for various groupings of modules.

According to the preferred embodiment of the invention, the device of the present invention further comprises a work routine program which is carried out by means of “off-line” programming techniques, which avoid having to program the system by teaching it the tasks to perform on a real specimen piece, in such a way that the totality of movements defined during the riveting process, including those of the positioning system and those of each single-function module, are governed by the same numerical control.

The method of the present invention uses the inventive device described above and among the above-mentioned consecutive operations it facilitates the following:

Operations of drilling, reaming and countersinking of different diameters;
checking the quality of drill-holes;
checking the thickness of pieces;
application of sealant in the drill-hole and/or the rivet to fit;
selection and supply of rivet, fastener or pin to fit;
fitting of the rivet, fastener or pin;
riveting or fastening;
checking the correct fitting of the rivet, fastener or pin;
cleaning;
adjustment operations on the aerodynamic tolerance;
checking of aerodynamic tolerance.

According to the inventive method, provision has been made for the operations of drilling, reaming, countersinking, sealing and riveting to be performed on the same work point prior to moving on to the following work point.

According to the inventive method, at a given work point the correct flanging of the pieces to be joined is ensured by means of a fastening installed in a position that is adjacent or sufficiently close. The fastening means are installed either during the pre-assembly phase prior to the method or automatically by the device corresponding to the method.

With the structure that has been described, the invention displays the advantages described below:

The invention eliminates the need for linear movements or the combination of these linear movements with rotary movements in the corresponding head, thereby effecting in a reduction in the weight of the riveting headstock.

By means of the invention it can be obviated the need to act, drive and control the movements of presenting each single-function module, whether by means of rotary or linear activations or a combination of them.

With this, the construction weight needed for the headstock is reduced, in such a way that machines with a very high payload are not necessary, nor are precision enhancement systems necessary in machines such as parallel kinematics machines, in such a way that the invention permits automatic riveting on a robotized platform by means of a conventional numerical control machine-tool of very high precision, a conventional numerical control machine-tool of standard precision, a parallel kinematics machine or in general any systems, robotized or controlled by numerical control, with sufficient precision and repetitiveness.

By means of simplifying the requirements contributed by the present invention, it also permits a reduction in the number of activations required, a reduction in the unitary costs of the automatic riveting system, making it more efficient in economic terms than the traditional systems of automatic riveting, and considerably enhancing the reliability and maintainability due to the reduction in the amount of activations and therefore the number of elements liable to suffer failure or malfunction during the useful life of the device.

Therefore, the main advantages contributed by the present invention consist of eliminating the need for a very high precision robotic architecture, reducing the weight of the head and therefore permitting its use with traditional numerical control machines, such as “gantry”, “portal”, “C” or others but without being limited to them, in such a way that parallel kinematics machines and precise articulated robots can also be used. Additionally, the invention eliminates the need for own activations in each module and the need for a mechanism for changing of module, increasing the reliability and maintainability and lowering the costs of the device.

Furthermore, by means of the invention, the need to separate the pieces after the drilling is eliminated, since the correct and firm securing among the pieces is ensured and the burrs and swarfs or shavings produced during the drilling by means of the rivet fitted previously by the inventive device are minimized. By permitting the device to fit rivets of different diameters and lengths, one will always have the certainty that in a specific work position there will always be a position that is sufficiently close or a rivet or temporary fastening coming from a pre-assembly phase, or a rivet fitted automatically by the device, which ensures the firm securing between the plates to rivet.

So, different types of rivets can be used and a process can be achieved in which the automatic riveting of pieces is carried out in which the variety of types, diameters and lengths of rivet that are important, and all this without the necessity of making stops in order to make changes of tools, modules, etc., which would increase the cycle times and, therefore, diminish the economic profitability of the method.

Below, in order to facilitate a better understanding of this descriptive specification and forming an integral part thereof, some figures are attached in which the object of the invention has been represented by way of illustration and non-limiting.

### BRIEF DESCRIPTION OF THE FIGURES

FIGS. 1 to 4.—Represent respective schematic views in perspective of four devices embodied according to the present invention and that employ the method thereof.

FIGS. 5 to 7.—Represent respective schematic plan views of three possibilities for a head existing in any of the above FIGS. 1 to 4.

### DESCRIPTION OF A PREFERRED EMBODIMENT OF THE INVENTION

A description is made forthwith of an example of the invention making reference to the numbering adopted in the figures.

So, the device and method of this example are applied to the union of pieces (4) by means of rivets in the aerospace industry, the device having a machine or robot (1, 5, 6, 7) moved by numerical control, which can be displaced on some rails (2) and which includes a head (3) fitted with an array or plurality of single-function modules (8) effecting various consecutive operations on a single work point, in such a way that the modules (8) are presented to the work point by the corresponding positioning system.

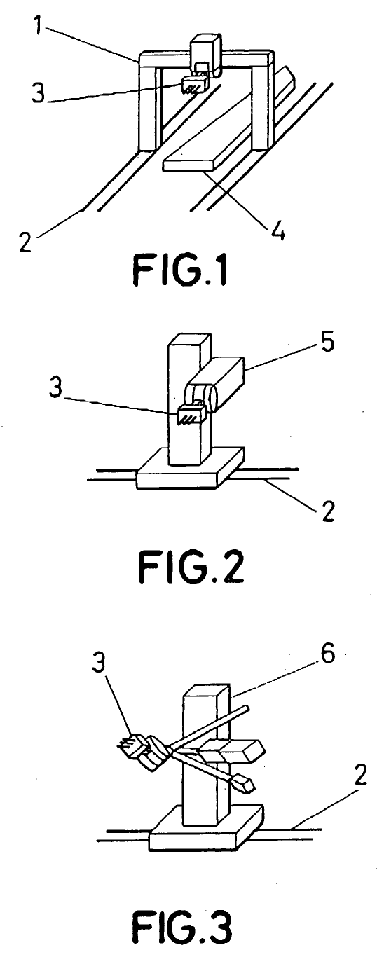

The machine or robot consists of a gantry machine (1) in FIG. 1, a column machine (5) in FIG. 2, a parallel kinematics machine (6) in FIG. 3 and an anthropomorphic robot (7) in FIG. 4.

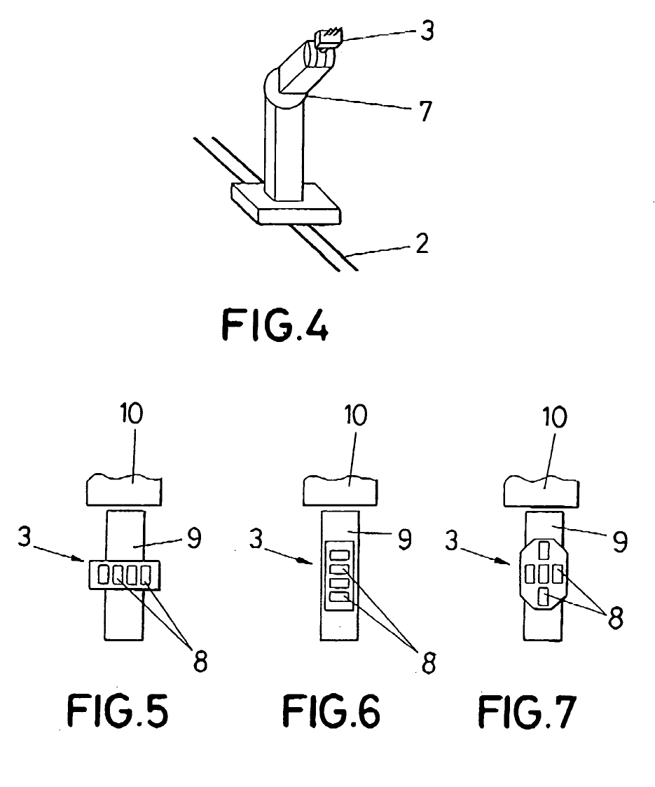

In any of these four cases, the head (3) presents a frame or chassis (9) that is joined to the carrier system by means of a wrist (10), as represented in FIGS. 5 to 7.

The single-function modules 8 of the headstock 3 can be arranged therein in a way that is transverse, longitudinal or in matrix or grid form, as shown respectively in FIGS. 5, 6 and 7.

According to the method described above, the device of the present example can perform various micro-operations on a single work position such as for example the operations of drilling, reaming and countersinking of different diameters, checking the quality of drill-holes, checking the thickness of pieces, application of a sealant in the drill-hole and/or in the rivet, fastener or pin to fit, selection and supply of rivet, fastener or pin to fit, fitting of the rivet, fastener or pin, riveting, checking the correct fitting of the rivet, cleaning, adjustment operations of aerodynamic tolerance, operations on checking of aerodynamic tolerance, or others.

According to the present example, the above-mentioned micro-operations are performed by means of the head (3) which is governed by multifunctional numerical control, presenting the capacity for fitting rivets of different lengths and diameters without the need to make changes of any piece and/or adapter in the system, and in which the different modules (8) in charge of performing each micro-operation do not need their own activations in order to be presented to the work point. Instead, it is the actual conventional numerical control machine-tool, parallel kinematics machine or in general any robotized system or one controlled by numerical control with sufficient precision and repetitiveness that carries out the movements of presenting each module (8) to the work point, machines such as those illustrated in FIGS. 1 to 4 and referenced as (1, 5, 6 and 7).

The method of the present example permits carrying out of automatic riveting in pieces that are typical in the aerospace industry by means of the fitting of blind rivets (of one or several pieces and with activation and fitting on just one side of the structure, such as for example, though without being limited to, those covered by Patents U.S. Pat. No. 5,816,761, U.S. Pat. No 4,457,652, U.S. Pat. No. 4,967,463, U.S. Pat. No. 4,747,202 and standard EN6122 and family), or rivets consisting of two pins and closure collars (such as for example, though without being limited to, breakable collars of the type Hi-LOK or Hi-LITE or of the LOCKBOLT funnel type or those covered by Patents U.S. Pat. No. 4,221,152, U.S. Pat. No. 4,198,895, U.S. Pat. No. 4,325,418, U.S. Pat. No. 4,472,096, U.S. Pat. No. 3,915,053, U.S. Pat. No. 2,882,773, U.S. Pat. No. 2,927,491, U.S. Pat. No. 2,940,495, U.S. Pat. No. 3,027,789, U.S. Pat. No. 3,138,987, U.S. Pat. No. 3,390,906).

The device and method of the present example permit very strict tolerances and make it possible for pieces to be joined by rivets in which the pieces are made of metal, composite, carbon fiber, “Kevlar”, fiber glass, “glare” or others, or combinations of the above materials.

In the present example, a mechanism has been provided for bringing the modules (8) closer or further away so that, during the operation of one module (8), another, that is not being used, is prevented from colliding with the piece (4) or the securing tool of the latter. This mechanism can be pneumatic, electrical or of any kind commonly used, and depending on the case it will not need to be very precise in its advance, for example in the case of being applied to a sealant applicator module. In other cases, said mechanism can be replaced by the actual advance provided by the numerical control positioning system, thereby obtaining in the advance the same characteristics of precision and repetitiveness as those prior to the positioning system. This can be the case of, for example, the advance of a drilling electro-spindle. Moreover, a single advance mechanism can be used for one or more modules (8) alternatively, thereby helping to reduce the number of elements, weight, complexity, cost, maintainability, etc. The advance of the modules (8) will in any case be governed by means of the numerical control which controls both the movements of the positioning system and those of the modules (8).

Each module (8) can be single-function, in the sense of performing a micro-operation within the work cycle, though it does not need to be limited to one specific type of rivet. For example, the module for application of sealant on the stem of the rivet or on the corresponding hole will be limited to performing the micro-operation of applying the sealant, but it does not need any manual or automatic external change for applying sealant on drill-holes of different sizes.

The positioning system on which the head (3) of the present example is arranged will position that head (3) on the point where the complete cycle is to be carried out and moreover, within each micro-operation, it will present each module (8) to the work point.

Since the device of the present invention has low weight, the corresponding positioning system does not need to be very heavy, so, since it is lighter, it can incorporate further modules (8) that will perform further operations on the work point, enhancing the riveting performance based on heavier positioners.

According to the present example, the inventive device can effect the method thereof in the following manner:

Preliminary phase in which the pieces to rivet are prepared manually or automatically, applying interposition sealant and supplement if necessary, and joining them by means of temporary or permanent fastenings in a certain percent such that ensures a correct initial flanging of the pieces to rivet, and the later placement of the piece on a tool.

The positioning system will consecutively present the different modules of the multifunctional head system to the same point, with each of the different modules (8) performing its function.

Once the operations on a single work point have been completed, the positioner will displace the automatic riveting system to the following work point. Here, the correct flanging of the pieces to be joined will be ensured by means of a fastening fitted in an adjacent position. Said fastening will be fitted either during the previous phase of the process or automatically by the device of the present invention.

The method will be possible to the degree that the device is capable of admitting a variety of rivets to fit (type, diameter, length, etc.), and this will be possible since the headstock 3, being of lesser weight, can include new modules 8 which allow the types of rivet to fit to be expanded. Since a greater variety of rivets can be fitted, this ensures that the system will always be able to rivet during the process, so one will always have the certainty that there will always be a position sufficiently close to the work position or there will always be a rivet or temporary fastening coming from a pre-assembly phase or there will be a rivet automatically installed by the device, which ensures firm securing between the pieces to rivet.

Once the automatic fitting of the rivets has been carried out, it will be possible to conduct an inspection of the rivets that have been fitted, by means of a checking module installed in the head (3). It will also be possible to conduct this function after the fitting of each rivet and prior to the fitting of the following rivet.

So, a method is obtained that is easy to carry out and which does not depend on whether the variety of rivets to fit is small or large, facilitating the assembly of large size structures with strict tolerances like those typical of the aerospace industry. By ensuring correct flanging during the drilling, it is ensured that no swarfs or dust of composite material is generated at the interface of the different pieces to join, eliminating the need to separate the pieces in order to clean them. So, there is no need to have to add an extra step to the process, which results in a considerable reduction in manufacturing costs.

Additionally, according to the present example, the work routine programs that are being used employ off-line programming technique which do not require programming the systems by using a real specimen piece to teach them the tasks to perform.

1. Multifunctional device for automatic riveting by numerical control, applicable to the union by means of riveting of metallic pieces, carbon fiber pieces, glass fiber pieces or other pieces with strict manufacturing tolerances such as those pieces required in the aerospace industry; the device comprising a machine or robot (1, 5, 6, 7) provided with a high precision positioning system, moved by numerical control and provided with a head (3) which is applied to the pieces to treat (4); wherein the head (3) presents a plurality of single-function modules (8), each of them carrying out consecutive operations on a single work point in such a way that said single-function modules (8) are presented to said work point by the positioning system; the positioning system comprises a numerical control Cartesian machine, gantry, portal, “C”, or other, a parallel kinematics machine or robot, a precise articulated robot, or a machine or robot with sufficient precision and repetitiveness for being applied to large structures with strict tolerances; while the different single-function modules (8) are arranged on a frame (9) which is rigidly and precisely joined to the union flange of the positioning system, said modules (8) being located transversely, longitudinally or in a matrix on the frame (9), or being adapted to the accessibility limitations imposed by the piece to join or the securing tool for it.

2. Multifunctional device for automatic riveting by numerical control, according to claim 1, wherein each single-function module (8) is provided with it own mechanism which brings it closer to or further away from the piece to treat (4) and which is, in some cases, replaced by the actual advance provided by the numerical control positioning system, said mechanism being independent for each module (8), having joint actuation for all the modules (8), or being independent for various groupings of modules (8).

3. Multifunctional device for automatic riveting by numerical control, according to claim 1, wherein it further comprises a work routine program which is carried out by means of “off-line” programming techniques, which avoid having to program the system by teaching it the tasks to perform on a real specimen piece, in such a way that the totality of movements defined during the riveting process, including those of the positioning system and those of each single-function module, are governed by the same numerical control.

4. Method, which uses the device claimed above, wherein the consecutive operations comprise:
Operations of drilling, reaming and countersinking of different diameters;
checking the quality of drill-holes;
checking the thickness of pieces;
application of sealant in the drill-hole and/or the rivet to fit;
selection and supply of rivet, fastener or pin to fit;
fitting of the rivet, fastener or pin;
riveting or fastening;
checking the correct fitting of the rivet, fastener or pin;
cleaning;
adjustment operations on the aerodynamic tolerance;
checking of aerodynamic tolerance.

5. Method, according to claim 4, wherein the operations of drilling, reaming, countersinking, sealing and riveting are performed on the same work point, prior to moving on to the following work point.

6. Method, according to claim 4, wherein, at a given work point, the correct flanging of the pieces to be joined is ensured by fastening means installed in a position that is adjacent or sufficiently close, said fastening means being installed either during the pre-assembly phase prior to the method or automatically by the device corresponding to the method.

7. Multifunctional device for automatic riveting by numerical control, according to claim 2, wherein it further comprises a work routine program which is carried out by means of “off-line” programming techniques, which avoid having to program the system by teaching it the tasks to perform on a real specimen piece, in such a way that the totality of movements defined during the riveting process, including those of the positioning system and those of each single-function module, are governed by the same numerical control.
